(19) United States
(12) Patent Application Publication
(10) Pub. No.: US 2011/0206941 A1
(43) Pub. Date: Aug. 25, 2011

(54) COPPER-TIN ALLOY, COMPOSITE MATERIAL AND USE THEREOF

(75) Inventors: Michael Koehler, Iserlohn (DE); Andreas Heide, Iserlohn (DE); Ralf Hojda, Altena (DE); Udo Riepe, Schwerte (DE)

(73) Assignee: SUNDWIGER MESSINGWERK GMBH & CO. KG, Hemer (DE)

(21) Appl. No.: 13/126,219

(22) PCT Filed: Oct. 27, 2009
(86) PCT No.: PCT/EP09/07669

§ 371 Date: Apr. 27, 2011

(30) Foreign Application Priority Data
Oct. 31, 2008 (DE) 10 2008 054 183.4

(51) Int. Cl. B32B 3/30; B32B 15/01; C22C 9/02

(52) U.S. Cl. 428/600; 428/647; 420/472

(57) ABSTRACT

The invention relates to a copper-tin alloy, comprising 0.2 to 0.8% by weight Sn, 0.1 to 0.6% by weight Ni and/or Co, 0 to 0.05% by weight Zn, 0 to 0.2% by weight Fe, 0.008 to 0.05% by weight P, and also Cu as remainder. The invention furthermore relates to a corresponding composite material having a base material made of such an alloy and also to suitable uses thereof. The technological and physical properties are comparable with those of a CuFe2P alloy. However, the alloy according to the invention and also a tin-plated composite material made thereof can be readily recycled.

The invention relates to a copper-tin alloy, to a composite material comprising such a copper-tin alloy and also to the use of the copper-tin alloy and of the composite material. The copper-tin alloy and the composite material which comprises the latter are suitable, in particular, for connection elements in electrical engineering and in electronics. In particular, the invention deals with the problem of recyclability.

At present, use is generally made of copper alloys based on Cu—Zn, Cu—Sn and Cu—Fe on a large scale for connection elements in electrical engineering and in electronics. In particular, such copper alloys are used for leadframes and plug-in connectors. Important criteria for the material selection in this respect are the modulus of elasticity, the yield strength, the relaxation behavior and the bendability. In addition to a sufficient mechanical strength, the electrical conductivity and the resistance to corrosion represent important criteria for the reliable operation of the components over the service life of the overall system. In this case, there is often an overlap of demands in terms of properties which, in principle, are mutually exclusive, for example the combination of a good conductivity with a high resistance to corrosion. If, on the one hand, alloying elements in the copper, such as nickel and chromium, improve the resistance to corrosion, then on the other hand they considerably reduce the conductivity.

The subject of weldability, in particular laser welding, to other metallic materials is also becoming increasingly important. In the light of the exorbitant price increases for metals in recent years, the subject of recyclability of the alloys used will also become more and more important in particular.

Cu—Zn or brass alloys are solid solution-strengthening materials. These are binary alloys which generally contain between 5 and 40% by weight zinc. The tensile strength and hardness increase as the zinc content rises. The elongation reaches a maximum value given 30% by weight zinc. Higher values in terms of strength and hardness can only be achieved by cold-forming.

A Vickers hardness of Hv=150 is usually required for plug-in connectors in the form of resilient strips, for example made of a CuZn30 alloy or of a CuZn37 alloy. In addition, a minimum bending radius r/s=1, which is standardized to the sheet thickness s, has to be observed given a 90° angle of bend. However, the disadvantage of the Cu—Zn alloys lies in the relatively poor weldability, because the alloying element zinc has a relatively high vapor pressure. At 1.013 bar, pure zinc already boils at 907° C. Furthermore, Cu—Zn alloys have a low modulus of elasticity of about 110 kN/mm² (SI unit: GPa). In addition, brass strips which have been tin-plated for reasons of protection against corrosion cannot be readily recycled owing to the tin introduced. The relaxation behavior of Cu—Zn alloys is also pronounced, and therefore the temperature at which they can be used is limited.

Cu—Sn alloys, i.e. tin bronzes, are some of the oldest technically utilizable copper alloys. An amount of phosphorus is usually added to the Cu—Sn alloys, and therefore said alloys are also referred to as phosphorus bronzes. The properties of these alloys are primarily determined by the tin content, which is generally between 4 and 8% by weight. Depending on the Sn content, the modulus of elasticity of phosphorus bronzes is between 115 and 120 kN/mm² (SI unit: GPa). The bendability of tin bronzes is outstanding. For a given tempering state, increasing Sn contents improve the bendability behavior. Resilient strips made of phosphorus bronze may readily be strengthened up to a hardness level of a Vickers hardness of Hv=200 and also have a bendability of r/s=1 given a 90° angle of bend. Tin or phosphorus bronzes are laser-weldable, because these alloys do not comprise any readily volatile elements (in particular zinc) or any interfering second phases. The relaxation behavior of tin or phosphorus bronzes is better than that of brass alloys, although it does not reach the level of hardenable copper materials.

Cu—Sn alloys are used in the form of strips for stamped parts and plug-in connectors if a good to very good resilient property, a good electrical and thermal load-bearing capacity, a low stress relaxation, a good bendability, good weldability and solderability are required. Phosphorus bronzes can also be readily recycled in tin-plated form. Tin is already present in the alloy as such.

The low-alloy copper materials include the Cu—Fe alloys. By adding small amounts of iron and phosphorus, it is possible to improve the material property of the pure copper, e.g. the strength, the softening behavior or relaxation behavior. A CuFe2P alloy in the tempering stage FH, in particular, is common for leadframes in automotive engineering. In this tempering stage, the material has a tensile strength of Rm=420 to 500 N/mm² (SI unit: MPa). The Vickers hardness is Hv=130 to 150. The sharp-edged bendability is still given. The advantages of the CuFe2P alloy include the fact that the modulus of elasticity is about 125 kN/mm² (GPa) and therefore the material has good resilient properties. The electrical conductivity is between 60% and 70% IACS (International Annealed Copper Standard: 100% IACS corresponds to about 58 MS/m). Tin-plating of the material for reasons of protection against corrosion is readily possible.

The disadvantages of the CuFe2P alloy include the fact that the latter does not form a homogeneous material, but instead has Fe2P precipitations. In particular, this makes laser welding more difficult. If the laser beam impinges on relatively coarse Fe2P precipitations during spot welding, it can be deflected, and the result of the penetration welding is thereby unsatisfactory. A further disadvantage is the poor recyclability of tin-plated scrap of the CuFe2P alloy. The electrical conductivity of a CuFe2P alloy is reduced by 25% in the case of melting by a tin which goes into solution by about 1% by weight. The tin-plated stamped scrap, which usually makes up 50% to 70% of the material used during the production of leadframes, cannot be recycled directly into the melting process, but instead has to be smelted and electrochemically separated in a complicated process. The scrap is accordingly recycled into the material cycle as a cathode. This operation is very energy-intensive and is therefore very expensive compared to the direct melting-down of the scrap.

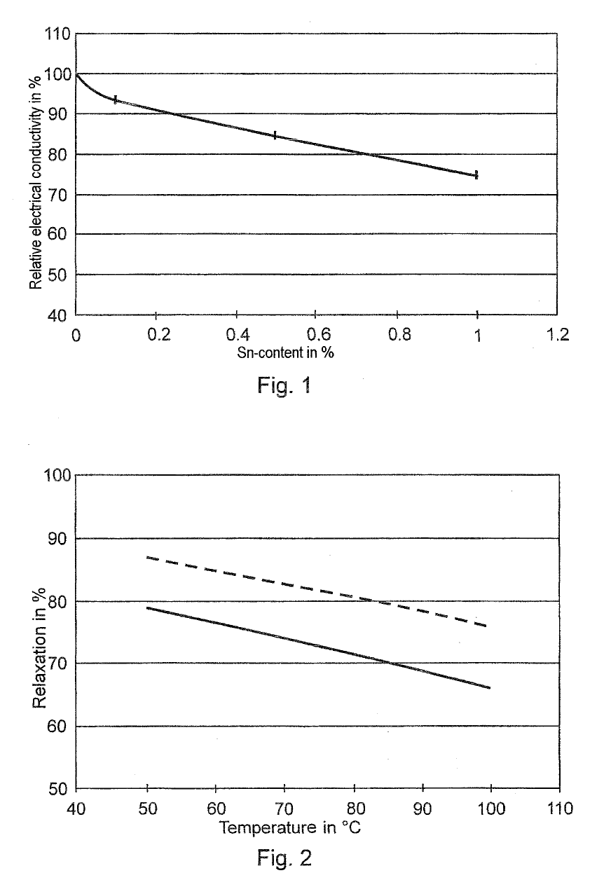

The influence of a tin content on the electrical conductivity, which has been outlined, will become clear for a CuFe2P alloy from FIG. 1. The electrical conductivity falls drastically above tin contents of as little as 0.3% by weight. If, by way of example, a strip made of a CuFe2P alloy having a thickness of 0.4 mm is coated on both sides with about 3 μm of tin for reasons of protection against corrosion, a CuFe2P alloy contaminated with about 1.5% by weight tin would result in the event of direct recycling on the basis of this scrap. In addition to drastic losses in the electrical conductivity, this tin content also has a strong negative effect on the solidification behavior.

It is an object of the invention to specify an alloy and a composite material which corresponds in terms of its physical and technological properties as far as possible to those of a CuFe2P alloy, can be laser-welded as readily as possible and can readily be recycled. It is a further object to specify a use for such an alloy and for such a composite material.

With regard to the alloy, the object mentioned above is achieved by a copper-tin alloy having the composition as claimed in claim 1. Accordingly, the copper-tin alloy comprises 0.2 to 0.8% by weight tin (Sn), 0.1 to 0.6% by weight nickel (Ni) and/or cobalt (Co), 0 to 0.05% by weight zinc (Zn), 0 to 0.02% by weight iron (Fe), 0.008 to 0.05% by weight phosphorus (P), and also copper (Cu) as remainder.

Here, the invention proceeds from the concept of specifying a new alloy which is an alternative to the CuFe2P alloy, has comparable properties but can also be readily recycled in the tin-plated state. Pure Cu—Sn alloys, such as for example a CuSn0.15 alloy, are undoubtedly able to be used as such an alternative. The scrap of such an alloy, when coated with tin, can be fed directly to the material cycle. In this case, the mechanical and technological properties correspond relatively well to those of a CuFe2P alloy. However, clear flaws arise in the softening behavior and the resistance to relaxation.

Extensive investigations have now shown that a copper-tin alloy with a targeted coordination of the alloying elements tin, nickel and/or cobalt and also phosphorus achieves both mechanical and technological properties comparable to a CuFe2P alloy and also the profile of properties required for the respective further processing and end application in terms of the softening behavior and the relaxation, i.e. the creep of the component under stress at elevated temperature. Here, either nickel or cobalt is present in the given content. In this context, it is preferable for some of the nickel to be replaced by cobalt, in which case the sum of both alloying elements together then gives the given content.

The table below shows a comparison between the technological and physical properties of the Cu—Sn alloy according to the invention and those of a CuFe2P alloy:

| | CuFe2P | CuSnNiCoP |
|---|---|---|
| Tensile strength Rm [MPa] | 450 | 438-440 |
| Yield point 0.2% R_{p0.2} [MPa] | 420 | 405-430 |
| Elongation at break A50 [%] | 9 | 4-5 |
| Modulus of elasticity [GPa] | 123 | 126 |
| Electrical conductivity [% IACS] | 63 | 55-70 |
| Thermal conductivity [W/mK] | 260 | 250 |
| Minimum bending radius [r/s, 90°] | 1 | 1 |
| Coefficient of thermal expansion | 17.7 × 10⁻⁶ | 17.7 × 10⁻⁶ |
| [Rt-100° C.] | | |
| Vickers hardness [Hv] | 145 | 130-134 |
| Softening temperature [° C. (1h)] | 350 | 350 |

It is clear from the table that the Cu—Sn alloy according to the invention satisfies the given requirements in terms of the technological and physical properties.

If the Cu—Sn alloy according to the invention is used in tin-plated form, an alloy layer is formed between the base material and the tin coating. It is not necessary to adapt the production equipment when changing over to the new material.

In addition, the Cu—Sn alloy mentioned above shows a profile of properties comparable to the CuFe2P alloy in terms of the softening behavior and the relaxation. This is clear from FIG. 2, in which the relaxation in % is plotted against the temperature in ° C. In this figure, the dashed line shows the behavior of the CuFe2P alloy and the solid line shows the behavior of the new Cu—Sn alloy mentioned above. The tests were carried out for a load time of 5000 hours and under an initial stress of 65% R_{p0.2}.

The new Cu—Sn alloy is further distinguished in particular by the direct recyclability of tin-plated scrap from the individual stages of the supply chain. The tin-plated scrap can be recycled directly into the melting process, and therefore the recycling costs are much lower compared to smelting. Given a scrap content of 70%, for example, the smelting costs can quickly reach the level of the production costs and question the economic viability. For this reason, an inspection of the metal values between a copper-iron alloy, such as the CuFe2P alloy, and the Cu—Sn alloy according to the invention also does not alter the fact that the alloy according to the invention is a reasonable alternative to tin-plated copper-iron alloys both from economical and ecological points of view (the additional use of power and acid for the electrolytic conditioning of the scrap can be dispensed with).

With regard to the required properties, it is advantageous if the copper-tin alloy according to the invention has an Sn content of between 0.3 and 0.7% by weight, in particular of between 0.4 and 0.6% by weight. A further advantageous adjustment of the properties can be made if the copper-tin alloy has an Ni and/or Co content of between 0.2 and 0.55% by weight, in particular of between 0.3 and 0.5% by weight.

A preferred phosphorus content of between 0.008 and 0.03% by weight, in particular of between 0.008 and 0.015% by weight, can improve the strength.

In a preferred alloy composition, the copper-tin alloy comprises 0.3 to 0.7% by weight Sn, 0.2 to 0.55% by weight Ni and/or Co, 0 to 0.04% by weight Zn, 0 to 0.015% by weight Fe, 0.08 to 0.03% by weight P, and also Cu as remainder.

The copper-tin alloy is improved further if it comprises 0.4 to 0.6% by weight Sn, 0.3 to 0.5% by weight Ni and/or Co, 0 to 0.03% by weight Zn, 0 to 0.01% by weight Fe, 0.008 to 0.015% by weight P, and also Cu as remainder.

A further advantageous accurate adjustment of the properties of the copper-tin alloy can be made if the sum of impurities and other admixtures is at most 0.3% by weight.

As a specific exemplary embodiment with outstanding properties, mention is made of a copper-tin alloy comprising 0.38% by weight Sn, 0.30% by weight Ni and/or Co, 0.003% by weight Zn, 0.008% by weight Fe, 0.014% by weight P, and also Cu as remainder.

The new copper-tin alloy is very readily laser-weldable since it does not contain any readily volatile elements and the alloy is free of a second phase. In particular, the alloy does not comprise any NiP precipitations.

The alloy is outstandingly suitable for a readily laser-weldable composite material, which can be used, in particular, for leadframes. At present, such leadframes are used, for example, in automotive engineering for ABS and ESP systems. For this purpose, a base material made of the copper-tin alloy mentioned above is provided or covered with a layer of tin; this can be carried out, in particular, by the hot tin plating process. In this respect, there is a layer of pure or free tin on the base material made of the copper-tin alloy according to the invention. The composite material is distinguished by a high resistance to relaxation up to temperatures of 100° C. In the interior, as a core, it comprises the copper-tin alloy according to the invention with a composition according to the claims directed thereto. The outer tin coating or covering ensures a high resistance to corrosion. The thickness of the layer of tin is preferably between 1 and 3 μm.

When tin-plating the copper-tin alloy according to the invention, a transition layer is formed between the base material and the layer of tin. The layer of tin is preferably applied in such a manner that the transition layer comprises an intermetallic phase of Cu, Ni and/or Co and also Sn. The transition layer is formed, in particular, in such a manner as to have a thickness of between 0.1 and 1 μm. In this respect, in the interior or as a core, the composite material comprises the copper-tin alloy according to the invention with the appropriate contents of nickel and/or cobalt and also phosphorus. The alloy of the core merges via the transition layer into a layer made of pure tin. A good bond of the layer of tin is achieved via the transition layer or alloy layer formed.

If a three-dimensional structure is considered, such as a leadframe made of the composite material, the overall result is a structure having five layers. A layer of an intermetallic phase consisting of CuNiCoSn and having a thickness of between 0.1 and 1.0 μm is provided on both sides of a core made of the copper-tin alloy according to the invention as the base material. For reasons of protection against corrosion, the composite material is finally covered with a layer which is made of free or pure tin and has a thickness of 1.0 to 3.0 μm. In total, the layer composite material has an overall thickness of 0.2 to 1 mm, preferably to 2 mm, particularly preferably to 3 mm.

The electrical conductivity of the composite material according to the invention corresponds to that of the comparative material CuFe2P used to date. The thermal conductivity and other technological values of the composite material are likewise fully comparable.

Both the copper-tin alloy according to the invention and the tin-plated composite material are outstandingly suitable for strips, foils, profiled strips, stamped parts or plug-in connectors, in particular for applications in electrical engineering or in electronics.

1. A copper-tin alloy, comprising:
02 to 0.8% by weight Sn,
0.1 to 0.6% by weight Ni and/or Co,
0 to 0.05% by weight Zn,
0 to 0.02% by weight Fe,
0.008 to 0.05% by weight P,
and Cu as remainder.

2. The copper-tin alloy as claimed in claim 1,
having an Sn content of between 0.3 and 0.7% by weight.

3. The copper-tin alloy as claimed in claim 1,
having an Ni and/or Co content of between 0.2 and 0.55% by weight.

4. The copper-tin alloy as claimed in claim 1, having a P content of between 0.008 and 0.03% by weight.

5. The copper-tin alloy as claimed in claim 1, comprising:
0.3 to 0.7% by weight Sn,
0.2 to 0.55% by weight Ni and/or Co,
0 to 0.04% by weight Zn,
0 to 0.015% by weight Fe,
0.008 to 0.03% by weight P,
and Cu as remainder.

6. The copper-tin alloy as claimed in claim 5, comprising:
0.4 to 0.6% by weight Sn,
0.3 to 0.5% by weight Ni and/or Co,
0 to 0.03% by weight Zn,
0 to 0.01% by weight Fe,
0.008 to 0.015% by weight P,
and Cu as remainder.

7. The copper-tin alloy as claimed in claim 1, in which the sum of impurities and other admixtures is at most 0.3% by weight.

8. A composite material having a base material comprising the copper-tin alloy as claimed in claim 1 and a layer of tin applied thereto.

9. The composite material as claimed in claim 8,
wherein the layer of tin has a thickness of between 1 and 3 μm.

10. The composite material as claimed in claim 8,
having a transition layer between the base material and the layer of tin, wherein the transition layer comprises an intermetallic phase of Cu, Ni and/or Co and Sn.

11. The composite material as claimed in claim 10,
wherein the transition layer has a thickness of between 0.1 and 1 μm.

12. Strips, wires, foils, profiled strips, stamped parts or plug-in connectors comprising the copper-tin alloy as claimed in claim 1.

13. Strips, wires, foils, profiled strips, stamped parts or plug-in connectors comprising the copper-tin alloy as claimed in claim 8.

14. The copper-tin alloy as claimed in claim 1, having an Sn content of between 0.4 and 0.6% by weight.

15. The copper-tin alloy as claimed in claim 1, having an Ni and/or Co content of between 0.3 and 0.5% by weight.

16. The copper-tin alloy as claimed in claim 1, having a P content of between 0.008 and 0.015% by weight.
